(19) United States
(12) Patent Application Publication
(10) Pub. No.: US 2009/0055132 A1
(43) Pub. Date: Feb. 26, 2009

(54) DETERMINING SITUATIONAL PATTERNS OF USE FOR COMPUTING SYSTEMS

(75) Inventors: Doreen Cheng, San Jose, CA (US); Yu Song, Pleasanton, CA (US); Hyuk Cho, Austin, TX (US); Sangoh Jeong, Palo Alto, CA (US); Swaroop Kalasapur, Sunnyvale, CA (US)

Correspondence Address: Beyer Law Group LLP, P.O. BOX 1687, Cupertino, CA, 95015-1687, US

(73) Assignee: Samsung Electronics Co., Ltd., Suwon City (KR)

(21) Appl. No.: 12/041,389

(22) Filed: Mar. 3, 2008

Related U.S. Application Data
(60) Provisional application No. 60/965,963, filed on Aug. 22, 2007.

(51) Int. Cl. G06F 15/00

(52) U.S. Cl. 702/187

(57) ABSTRACT

Techniques for determining situational patterns of use of computing systems are disclosed. A situational pattern of use can be determined based on the situations encountered by the computing system as the situations occur without having to predefine a set of situations. Generally, a situation can be determined and/or defined based on the context of use of the computing system when the use occurs. The context of use can, for example, be determined based on internal and external variables including the physical environment where a device is used and biological data associated with a person who uses the device. The state of use of the computing system can, for example, be determined based on the state (or status) of one or more components of the computing system (e.g., the state of one or more active applications that are being used by person). Similar to the context of use, the state of use can be determined as the use occurs without having to predefine potential uses of the computing system (e.g., there is no need to predefine or know the applications that will be used on a device). Moreover, the state of use can be connected to context of use defining a situation in which the state of use has occurred to allow determining a pattern of use of the computing system at least based on the association of the state of use with the situation effectively defined by the contextual usage data which can be obtained as and when the use occurs.

### CROSS-REFERENCE TO RELATED APPLICATION

The present application claims priority under 35 U.S.C. §119(e) from co-pending U.S. Provisional Patent Application No. 60/965,963, filed on Aug. 22, 2007.

### BACKGROUND OF THE INVENTION

Conceptually, a computing system (e.g., a computing device, a personal computer, a laptop, a Smartphone, a mobile phone) can accept information (content or data) and manipulate it to obtain or determine a result based on a sequence of instructions (or a computer program) that effectively describes how to process the information. Typically, the information used by a computing system is stored in a in a computer readable memory using a digital or binary form. More complex computing systems can store content including the computer program itself. A computer program may be invariable and/or built into, for example a computer (or computing) device as logic circuitry provided on microprocessors or computer chips. Today, general purpose computers can have both kinds of programming. A computing system can also have a support system which, among other things, manages various resources (e.g., memory, peripheral devices) and services (e.g., basic functions such as opening files) and allows the resources to be shared among multiple programs. One such support system is generally known and an Operating System (OS) which provides programmers with an interface used to access these resources and services.

Today, numerous types of computing devices are available. These computing devices widely range with respect to size, cost, amount of storage and processing power, from the expensive and powerful servers, relatively cheaper Personal Computers (PC's) and laptops, to more inexpensive microprocessors or computer chips provided in storage devices, automobiles, and household electronic appliances.

In recent years, computing systems have become more portable and mobile. As a result, various mobile and handheld devices have been made available. By way of example, wireless phones, media players, Personal Digital Assistants (PDA's) are widely used today. Generally, a mobile or a handheld device (also known as handheld computer or simply handheld) can be a pocket-sized computing device, typically utilizing a small visual display screen for user output and a miniaturized keyboard for user input. In the case of a Personal Digital Assistant (PDA), the input and output can be combined into a touch-screen interface.

In particular, mobile communication devices (e.g., mobile phones) have become extremely popular. Some mobile communication devices (e.g., Smartphones) offer computing environments that are similar to that provided by a Personal Computer (PC). As such, a Smartphone can effectively provide a complete operating system as a standardized interface and platform for application developers. Given the popularity of mobile communication devices, telecommunication is discussed in greater detail below.

Generally, telecommunication refers to assisted transmission of signals over a distance for the purpose of communication. In earlier times, this may have involved the use of smoke signals, drums, semaphore or heliograph. In modern times, telecommunication typically involves the use of electronic transmitters such as the telephone, television, radio or computer. Early inventors in the field of telecommunication include Alexander Graham Bell, Guglielmo Marconi and John Logie Baird. Telecommunication is an important part of the world economy and the telecommunication industry's revenue is placed at just under 3 percent of the gross world product.

Conventional telephones have been in use for many years. The first telephones had no network but were in private use, wired together in pairs. Users who wanted to talk to different people had as many telephones as necessary for the purpose. Typically, a person who wished to speak, whistled into the transmitter until the other party heard. Shortly thereafter, a bell was added for signaling, and then a switch hook, and telephones took advantage of the exchange principle already employed in telegraph networks. Each telephone was wired to a local telephone exchange, and the exchanges were wired together with trunks. Networks were connected together in a hierarchical manner until they spanned cities, countries, continents and oceans. This can be considered the beginning of the public switched telephone network (PSTN) though the term was unknown for many decades.

Public switched telephone network (PSTN) is the network of the world's public circuit-switched telephone networks, in much the same way that the Internet is the network of the world's public IP-based packet-switched networks. Originally a network of fixed-line analog telephone systems, the PSTN is now almost entirely digital, and now includes mobile as well as fixed telephones. The PSTN is largely governed by technical standards created by the ITU-T, and uses E.163/E.164 addresses (known more commonly as telephone numbers) for addressing.

More recently, wireless networks have been developed. While the term wireless network may technically be used to refer to any type of network that is wireless, the term is often commonly used to refer to a telecommunications network whose interconnections between nodes is implemented without the use of wires, such as a computer network (which is a type of communications network). Wireless telecommunications networks can, for example, be implemented with some type of remote information transmission system that uses electromagnetic waves, such as radio waves, for the carrier and this implementation usually takes place at the physical level or “layer” of the network (e.g., the Physical Layer of the OSI Model). One type of wireless network is a WLAN or Wireless Local Area Network. Similar to other wireless devices, it uses radio instead of wires to transmit data back and forth between computers on the same network. Wi-Fi is a commonly used wireless network in computer systems which enable connection to the internet or other machines that have Wi-Fi functionalities. Wi-Fi networks broadcast radio waves that can be picked up by Wi-Fi receivers that are attached to different computers or mobile phones. Fixed wireless data is a type of wireless data network that can be used to connect two or more buildings together in order to extend or share the network bandwidth without physically wiring the buildings together. Wireless MAN is another type of wireless network that connects several Wireless LANs.

Today, several mobile networks are in use. One example is the Global System for Mobile Communications (GSM) which is divided into three major systems which are the switching system, the base station system, and the operation and support system (Global System for Mobile Communication (GSM)). A cell phone can connect to the base system station which then connects to the operation and support station; it can then connect to the switching station where the call is transferred where it needs to go (Global System for Mobile Communication (GSM)). This is used for cellular phones and common standard for a majority of cellular providers. Personal Communications Service (PCS): PCS is a radio band that can be used by mobile phones in North America. Sprint happened to be the first service to set up a PCS. Digital Advanced Mobile Phone Service (D-AMPS) is an upgraded version of AMPS but it may be phased out as the newer GSM networks are replacing the older system.

Yet another example is the General Packet Radio Service (GPRS) which is a Mobile Data Service available to users of Global System for Mobile Communications (GSM) and IS-136 mobile phones. GPRS data transfer is typically charged per kilobyte of transferred data, while data communication via traditional circuit switching is billed per minute of connection time, independent of whether the user has actually transferred data or has been in an idle state. GPRS can be used for services such as Wireless Application Protocol (WAP) access, Short Message Service (SMS), Multimedia Messaging Service (MMS), and for Internet communication services such as email and World Wide Web access. 2G cellular systems combined with GPRS is often described as “2.5G”, that is, a technology between the second (2G) and third (3G) generations of mobile telephony. It provides moderate speed data transfer, by using unused Time Division Multiple Access (TDMA) channels in, for example, the GSM system. Originally there was some thought to extend GPRS to cover other standards, but instead those networks are being converted to use the GSM standard, so that GSM is the only kind of network where GPRS is in use. GPRS is integrated into GSM Release 97 and newer releases. It was originally standardized by European Telecommunications Standards Institute (ETSI), but now by the 3rd Generation Partnership Project (3GPP). W-CDMA (Wideband Code Division Multiple Access) is a type of 3G cellular network. W-CDMA is the higher speed transmission protocol used in the Japanese FOMA system and in the UMTS system, a third generation follow-on to the 2G GSM networks deployed worldwide. More technically, W-CDMA is a wideband spread-spectrum mobile air interface that utilizes the direct sequence Code Division Multiple Access signaling method (or CDMA) to achieve higher speeds and support more users compared to the implementation of time division multiplexing (TDMA) used by 2G GSM networks.

Generally, a mobile phone or cell phone can be a long-range, portable electronic device used for mobile communication. In addition to the standard voice function of a telephone, current mobile phones can support many additional services such as SMS for text messaging, email, packet switching for access to the Internet, and MMS for sending and receiving photos and video. Most current mobile phones connect to a cellular network of base stations (cell sites), which is in turn interconnected to the public switched telephone network (PSTN) (one exception is satellite phones).

The Short Message Service (SMS), often called text messaging, is a means of sending short messages to and from mobile phones. SMS was originally defined as part of the GSM series of standards in 1985 as a means of sending messages of up to 160 characters, to and from Global System for Mobile communications (GSM) mobile handsets. Since then, support for the service has expanded to include alternative mobile standards such as ANSI CDMA networks and Digital AMPS, satellite and landline networks. Most SMS messages are mobile-to-mobile text messages, though the standard supports other types of broadcast messaging as well. The term SMS is frequently used in a non-technical sense to refer to the text messages themselves, particularly in non-English-speaking European countries where the GSM system is well-established.

Multimedia Messaging Service (MMS) is a relatively more modern standard for telephony messaging systems that allows sending messages that include multimedia objects (images, audio, video, rich text) and not just text as in Short Message Service (SMS). It can be deployed in cellular networks along with other messaging systems like SMS, Mobile Instant Messaging and Mobile E-mal. Its main standardization effort is done by 3GPP, 3GPP2 and Ope Mobile Alliance (OMA).

The popularity of computing systems, especially mobile communication devices is evidenced by their ever increasing use in everyday life. Accordingly, techniques that can enhance computing systems and/or their use would be very useful.

### SUMMARY OF THE INVENTION

Broadly speaking, the invention relates to technique for improving computing systems and their use. More particularly, techniques for determining situational patterns of use of computing systems are disclosed. It will be appreciated that a situational pattern of use can be determined based on the situations encountered by the computing system as the situations occur without having to predefine a set of situations. Generally, a situation can be determined and/or defined based on the context of use of the computing system when the use occurs. The context of use can, for example, be determined based on internal and external variables including the physical environment where a device is used and biological data associated with a person who uses the device. The state of use of the computing system can, for example, be determined based on the state (or status) of one or more components of the computing system (e.g., the state of one or more active applications that are being used by person). Similar to the context of use, the state of use can be determined as the use occurs without having to predefine potential uses of the computing system (e.g., there is no need to predefine or know the applications that will be used on a device).

Moreover, the state of use can be connected to context of use defining a situation in which the state of use has occurred to allow determining a pattern of use of the computing system at least based on the association of the state of use with the situation effectively defined by the contextual usage data which can be obtained as and when the use occurs. In other words, the state of use of the computing system (e.g., the state of one or more applications being used, such as, for example, the state of a word processor) can be determined and connected to the context of the use (e.g., contextual variable such as, for example, temperature, physical location, heart beat of the person using the device). Generally, the state of use can be defined simply as desired (e.g., application active or not) or it can be defined using a very complex set of variables to provide as much information about the state of use as desired. For example, the state of use can include additional information pertaining to the state use and/or the manner of use (e.g., information pertaining to the use of one or more applications, as such, for example, how long an application has been open and what files it has opened, what number has been called and the duration of each call made by an communication application, input/output connected with an application). It should be noted that a situation can also be defined based on the state (or status) of one or more usable components of the computing systems (e.g., one or more applications). In other words, the state of use of one more usable components (e.g., one or more designated applications) can also be considered in addition to other contextual variables (e.g., temperature) in defining a situation. As such, one or more usable components can be defined to be effectively a part of the context of use, for example, for one or more other usable components. By way of example, the state of use of a first group of applications can be used as context variables combined with other context variable (e.g., environmental variables) in order to define a situation for a second group of applications (i.e., a situation associated with state of use of the second group of applications.

It will be appreciated that a situational pattern of use of a computing system provides valuable information with respect to the use of the computing system. As such, a situational pattern of use can be used to generally enhance the computing system and its use partly because more intelligent decisions can be made with respect to the computing system and its use. A situational pattern of use can improve numerous applications. By way of example, a situational pattern of use can be the basis for predicting the use of a computing system (e.g., the likelihood that one or more applications are used on a device given a particular situation, the likelihood that of one or more applications are being in particular manner in a given situation). It will be appreciated that a situational pattern of use can especially enhance mobile devices and their use by allowing a more intelligent design of the mobile devices. In particular, the ability to predict the manner of use can dramatically improve the manner in which mobile devices can be used.

In accordance with one embodiment of the invention, a computing system can determine a situational pattern of use based on integrated state and contextual usage data. The integrated state and contextual usage data includes at least: (a) a first state of use and (b) a first context for the computing system. The first context effectively represents a first situation associated with the first state of use of the computing system to effectively indicate that in the first situation the computing system has been used in accordance with the first state of use, thereby allowing a pattern of use to be determined for the computing system at least based on the association of the first state of use with said first situation

In another embodiment, a computing system is adapted for and/or capable of: obtaining a first state (or status) of use of the computing system based on the state of one or more components of said computing system, obtaining a first context effectively defining and/or indicates a first situation for the computing system, and generating integrated state and contextual usage data for the computing system including at least: (a) the first state of use and (b) the first context for the computing system effectively represented as a situation associated with the first state of use of the computing system, whereby effectively indicating that in the first situation the computing system has been used in accordance with the first state of use. Thereby, allowing a pattern of use to be determined for the computing system at least based on the association of the first state of use with the first situation.

The invention can be implemented in numerous ways, including, for example, a method, an apparatus, a computer readable medium, and a computing system (e.g., a computing device). Several embodiments of the invention are discussed below.

Other aspects and advantages of the invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings, wherein like reference numerals designate like structural elements, and in which:

FIG. 1A depicts computing systems in accordance with various embodiments of the invention.

FIG. 1B depicts a method for allowing a pattern of use to be determined for a computing system in accordance with one embodiment of the invention.

FIG. 1C depicts a method for determining a situational pattern of use for a computing system in accordance with one embodiment of the invention.

FIG. 2A depicts a computing system in greater detail in accordance with one embodiment of the invention.

FIG. 2B depicts a method for determining a pattern of use of a computing system in accordance with one embodiment of the invention.

FIG. 3A depicts a computing system in accordance with another embodiment of the invention.

FIG. 3B depicts a process for generating pattern of use data in accordance with one embodiment of the invention.

### DETAILED DESCRIPTION OF THE INVENTION

As noted in the background section, mobile computing devices have become increasing more popular in recent years. Today, wireless, mobile and/or portable communication devices (e.g., Smartphones, cell phones, Personal Digital Assistants) are especially popular. In recent years, mobile devices have evolved to provide increasingly more functions. As such, wireless and/or mobile communication devices (e.g., cell phones, SmartpPhones) have been more recently developed which can offer similar functionality as that more traditionally offered by Personal Computers (PCs).

Despite these advances, mobile (or portable) devices still need to work with relatively smaller input/output devices (e.g., displays, screens, keyboards). As such, the enhanced processing power and functionality provided by the newer mobile devices has ironically resulted in frustrating some individuals as it has become increasingly more difficult to navigate through numerous applications and functions. As a result, extensive efforts have been made by a number of entities to develop alternative techniques for interacting with mobile devices.

One approach is to allow the users of mobile devices to set their preferences individually. However, this approach does not fully realize and address the fact that the preferences may vary from one situation to the next situation. For example, an individual may have a different set of preferences at home than those preferred at the office. The same individual may have an entirely different set of preferences for using a mobile device on: a cold raining day as opposed to a worm sunny day, on an unusual weekday at home, versus a regular weekday at work or an occasional Saturday at work, and so on.

Other approaches require the user to effectively train the device over a period of time (“supervised training”). However, supervised training may not be an ideal or a desired solution for many applications as it requires the use to spend a significant amount of time and effort to actively train the device. Another drawback is that conventional approaches are not flexible and do not readily adapt to changes in preferences, environment, or habits associated with the use of the device. Therefore, improved techniques for enhancing mobile devices and/or their use are needed.

More generally, techniques the can generally enhance computing systems and/or their use would be very useful. Accordingly, the invention pertains to techniques for determining situational patterns of use of computing systems are disclosed. It will be appreciated that a situational pattern of use can be determined based on the situations encountered by the computing system as the situations occur without having to predefine a set of situations. Generally, a situation can be determined and/or defined based on the context of use of the computing system when the use occurs. The context of use can, for example, be determined based on internal and external variables including the physical environment where a device is used and biological data associated with a person who uses the device. The state of use of the computing system can, for example, be determined based on the state (or status) of one or more components of the computing system (e.g., the state of one or more active applications that are being used by person). Similar to the context of use, the state of use can be determined as the use occurs without having to predefine potential uses of the computing system (e.g., there is no need to predefine or know the applications that will be used on a device).

Moreover, the state of use can be connected to context of use defining a situation in which the state of use has occurred to allow determining a pattern of use of the computing system at least based on the association of the state of use with the situation effectively defined by the contextual usage data which can be obtained as and when the use occurs. In other words, the state of use of the computing system (e.g., the state of one or more applications being used, such as, for example, the state of a word processor ) can be determined and connected to the context of the use (e.g., contextual variable such as, for example, temperature, physical location, heart beat of the person using the device). Generally, the state of use can be defined simply as desired (e.g., application active or not) or it can be defined using a very complex set of variables to provide as much information about the state of use as desired. For example, the state of use can include additional information pertaining to the state use and/or the manner of use (e.g., information pertaining to the use of one or more applications, as such, for example, how long an application has been open and what files it has opened, what number has been called and the duration of each call made by an communication application, input/output connected with an application).

It should be noted that a situation can also be defined based on the state (or status) of one or more usable components of the computing systems (e.g., one or more applications). In other words, the state of use of one more usable components (e.g., one or more designated applications) can also be considered in addition to other contextual variables (e.g., temperature) in defining a situation. As such, one or more usable components can be defined to be effectively a part of the context of use, for example, for one or more other usable components. By way of example, the state of use of a first group of applications can be used as context variables combined with other context variable (e.g., environmental variables) in order to define a situation for a second group of applications (i.e., a situation associated with state of use of the second group of applications.

It will be appreciated that a situational pattern of use of a computing system provides valuable information with respect to the use of the computing system. As such, a situational pattern of use can be used to generally enhance the computing system and its use partly because more intelligent decisions can be made with respect to the computing system and its use. A situational pattern of use can improve numerous applications. By way of example, a situational pattern of use can be the basis for predicting the use of a computing system (e.g., the likelihood that one or more applications are used on a device given a particular situation, the likelihood that of one or more applications are being in particular manner in a given situation). It will be appreciated that a situational pattern of use can especially enhance mobile devices and their use by allowing a more intelligent design of the mobile devices. In particular, the ability to predict the manner of use can dramatically improve the manner in which mobile devices can be used.

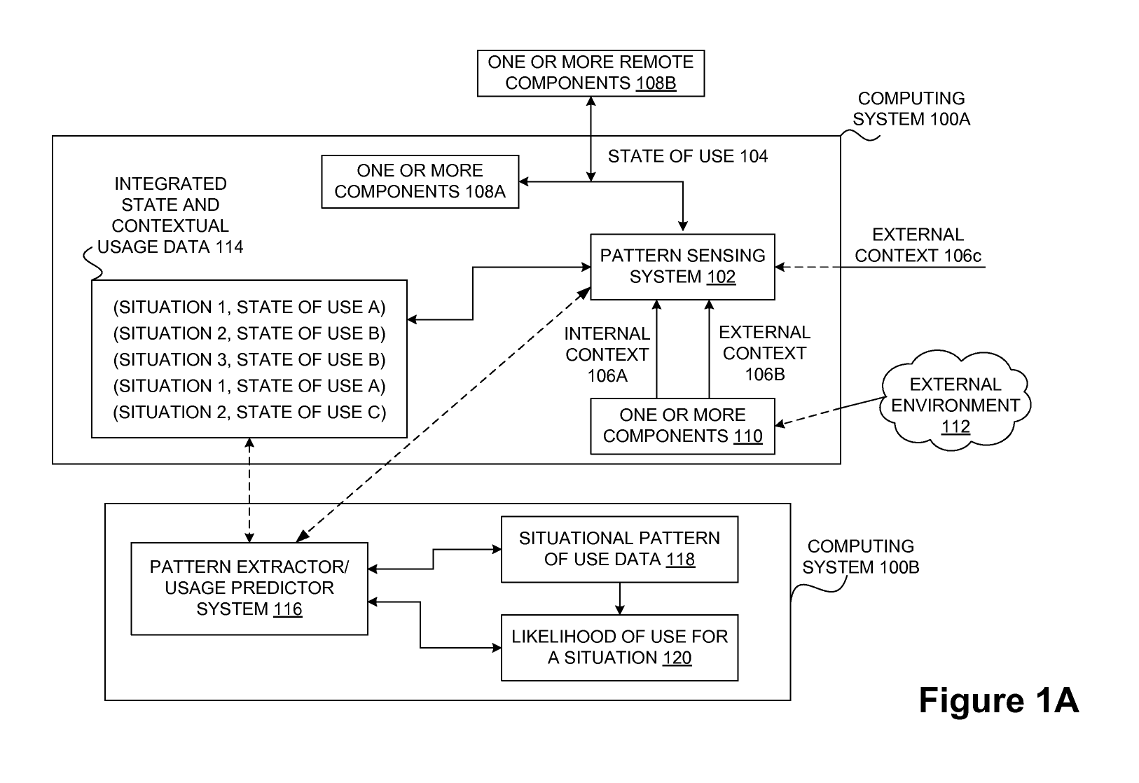

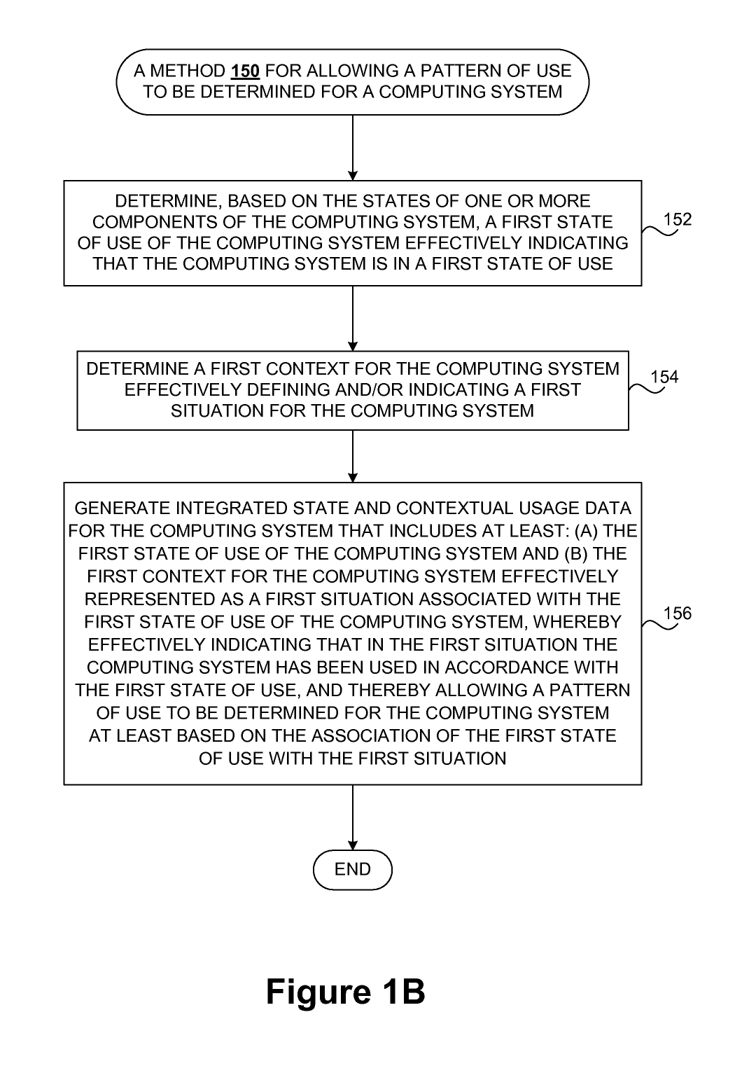

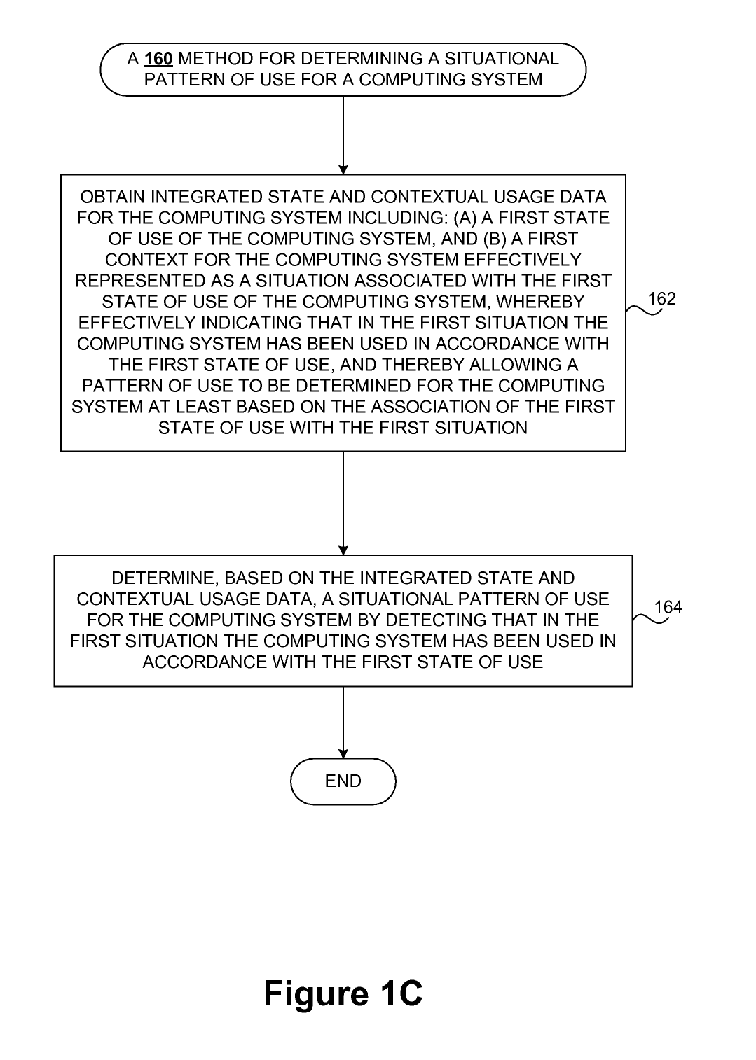

Embodiments of these aspects of the invention are discussed below with reference to FIGS. 1A-3B. However, those skilled in the art will readily appreciate that the detailed description given herein with respect to these figures is for explanatory purposes as the invention extends beyond these limited embodiments.

FIG. 1A depicts computing systems 100A and 100B in accordance with various embodiments of the invention. Those skilled in the art will appreciate that the computing systems 100A and/or 100B can, for example, be a computing device that includes one or more processors and memory (not shown). Referring to FIG. 1A, the computing system 100A effectively includes a pattern sensing system 102 adapted for and/or capable of obtaining a state (or status) of use 104 and contextual information (context) 106.

Typically, the state of use 104 is associated with and can be determined based on the state (or status) of one or more components 108 of the computing system 100A. The components 108 can include internal (108A) and remote (108B) components. The one or more components 108 can, for example, be one or more operational and/or executable components and/or usable components (e.g., one or more application programs being executed on the computing system 100A).

Similarly, the context 106 obtained by the pattern sensing system 102 can be associated and/or determined by or based on one or more components 110. As such, the component(s) 108 can be the same as the component(s) 110 or one or more different components. Generally, the pattern sensing system 102 obtains a context (e.g., a context of use) for the computing system 100A which can represent a situation for the computing system 100A. The context can be determined based on various internal and external factors including the state of use of one or components 108A. By way of example, the one or more components 110 can determine (e.g., measure) one or more factors, elements or variables associated with an external environment 112 and provide them to the pattern sensing system 102. As another example, internal context 106a representing the context of use of the computing system 100A may also be determined by and/or based on one or more components 108A and/or 110 and provided to the pattern sensing system 102. It should be noted that external context 106c can also be received, for example, directly from one or more other external components (not shown) and processed by the pattern sensing system 102. As such, the context of use of one or more components 108 and/or 110 and other context information 106 can both be considered by the pattern sensing system 102 in determining a situation.

In any case, the pattern sensing system 102 processes the state of use information 104 and contextual information 106 in order to generate integrated state and contextual usage data 114. It will be appreciated that the pattern sensing system 102 can effectively represent the contextual information 106 as the situation associated with the state of use 104. As such, the integrated state and contextual usage data 114 can effectively include a set of situations (e.g., situation 1, situation 2, and situation 3) with their respective (or associated) state of use (e.g., state of use A, state of use B, state of use C). By way of example, the integrated state and contextual usage data 114 can effectively indicate that in a first situation, (situation 1), the computing system 100A has been in a first state of use (state of use A), and so on. As result, the integrated state and contextual usage data 114 allows determining a pattern of use for the computing system 100A based on the association of a state of use with a particular situation in which the state of use has been effectively observed.

More particularly, the pattern extractor/usage predictor system 116 can effectively obtain the integrated state and contextual usage data 114 in order to determine situational pattern of use data 118 based on the association of the state of use and the situation in which the use has been observed. It will be appreciated that the pattern extractor/usage predictor system 116 can use the situational pattern of use data 118 for many applications. By way of example, the situational pattern of use data 118 can be used to determine the likelihood of use 120 of the computing system for a particular situation. As such, the likelihood of use 120 can, for example, effectively indicate the probability of the computing system 100A being used in a particular situation (e.g., situation 2) in accordance with a particular state of use (e.g., state of use C).

Those skilled in the art will readily appreciate that the pattern sensing system 102 and pattern extractor/usage predictor system 116 can be combined and provided for a single computing system (e.g., a computing device). In other words, a single computing system can effectively determine the integrated state and contextual usage data and use it to extract the situational pattern of use data 118 for a variety of applications including determining the likelihood of use 120. It should also be noted that the pattern sensing system 102 can be in communication with the pattern extractor/usage predictor system 116. As such, the pattern sensing system 102 can effectively communicate the integrated state and contextual usage data 114. In addition, the pattern extractor/usage predictor system 116 can effectively provide feedback to the pattern sensing system 102, for example, based on the situational pattern of use data 118 and/or the likelihood of use 120, in order to, for example, affect the information gathered by the pattern sensing system 102 including the state of use 104 and contextual information 106.

The pattern extractor/usage predictor system 116 can, for example, determine a pattern of use based on the frequency of occurrence of one or more states of use with respect to one or more situations. It will be appreciated that there is no need to provide the computing system 100A or 100B with supervised training in order to determine a pattern of use (e.g., pattern of use of the computing system 100A). Further, it will be appreciated that the situations effectively represented by the integrated state and contextual usage data 114 need not be predefined prior to their occurrence. In other words, situations can be defined as they occur. As such, the pattern of use data 118 can, for example, be used in a dynamic manner to define and/or affect the information being obtained. Similarly, states of use need not be predefined prior to their occurrence. As a result, the computing systems 100A and 100B can readily adapt to new uses (e.g., new applications and/or tasks) and situations, as well as a change in usage (e.g., a change with respect to applications that are frequently used, use of a device by a different user or a user with different habits) and/or change in situations associated with the use of the computing system (e.g., using a device that has been used in an office at home, moving to a different geographical location).

FIG. 1B depicts a method 150 for allowing a pattern of use to be determined for a computing system in accordance with one embodiment of the invention. The method 150 can, for example, be performed by the computing system 100A depicted in FIG. 1A. Initially, a first state of use of the computing system is determined (152) based on the state of one or more components of the computing system. The first state of use of the computing system effectively indicates that the computing system is in a first state of use. Next, a first context for the computing system is determined (154). The first context effectively defines a first situation for the computing system. Thereafter, integrated state and contextual usage data for the computing system is generated (156). The integrated state and contextual usage data includes at least the first state of use and first context for the computing system represented as a first situation associated with the first state of use, whereby effectively indicating that in the first situation the computing system has been used in accordance with the first state of use. It will be appreciated that the integrated state and contextual usage data allows a pattern of use to be determined for the computing system at least based on the association of the first state of use with the first situation effectively represented by the first context. The method 150 ends after the integrated state and contextual usage data is generated (156).

FIG. 1C depicts a method 160 for determining a situational pattern of use for a computing system in accordance with one embodiment of the invention. The method 160 can, for example, be performed by computing system 100B shown in FIG. 1A. Initially, integrated state and contextual usage data is obtained (162) for the computing system. The integrated state and contextual usage data includes a first state of use and a first context for the computing system. The first context effectively represented as a first situation associated with the first state of use of the computing system, whereby effectively indicating that in the first situation, the computing system has been used in accordance with the first state of use. It will be appreciated that the integrated state and contextual usage data allows the pattern of use to be determined for the computing system at least based on the association of the first state of use with the first situation. Accordingly, a situational pattern of use is determined (162) based on the integrated state and contextual usage data by detecting that in the first situation the computing system has been used in accordance with the first state of use. The method 160 ends after the situational pattern of use has been determined (164).

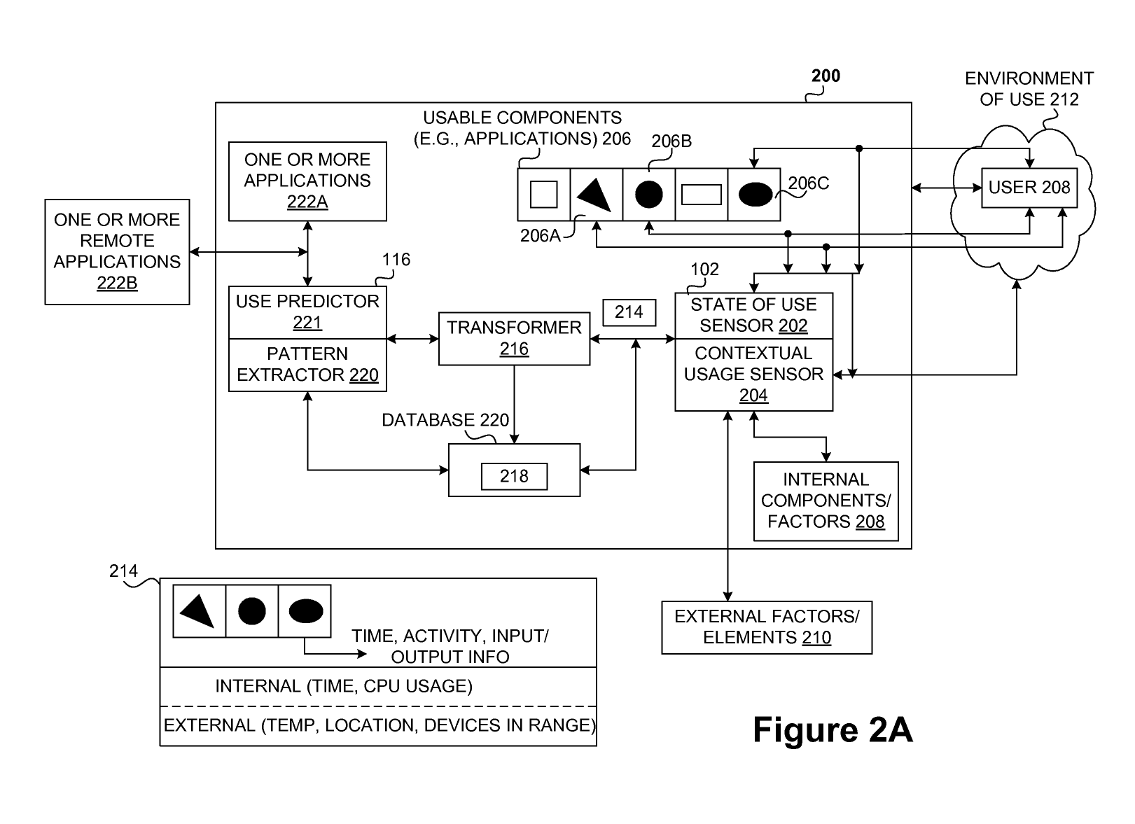

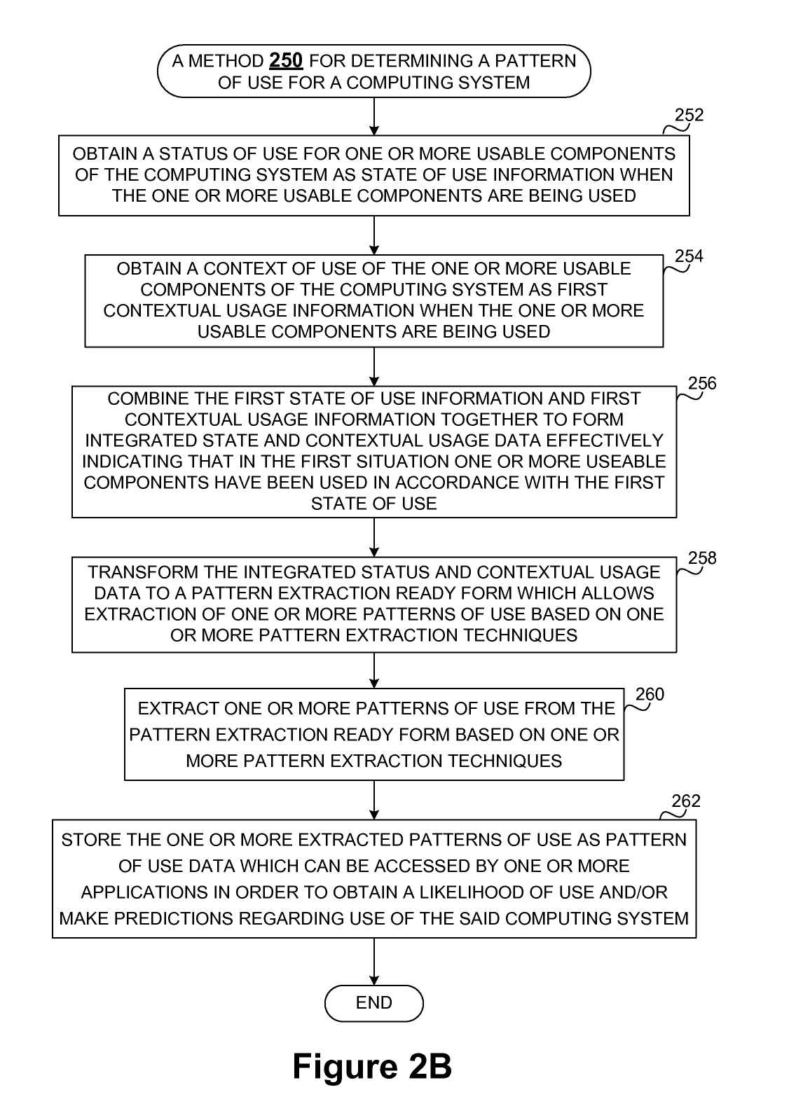

As noted above, the pattern sensing system 102 and the pattern extractor/usage predictor system 116 can be effectively combined and provided by the same computing system. To further elaborate, FIG. 2A depicts a computing system 200 in greater detail in accordance with one embodiment of the invention. Referring to FIG. 2A, the computing system 200 effectively provides a pattern sensing system 102 and a pattern extractor/usage predictor 116. The pattern sensing system 102 includes the state of use sensor 202 and the contextual usage sensor 204. The state of use sensor 202 can effectively sense the state of use of one or more usable components 206 of the computing system 200. Generally, the one or more usable components 206 can be one or more hardware and/or software components of the computing system 200. By way of example, the usable components 206 can include one or more application programs that are being effectively used by a user 208 (e.g., one or more persons, one or more end-user application programs, one or more computing components or devices). As such, the state of use sensor 202 can, for example, sense the state of one or more usable components 206 which are active and being used by one or more persons 208 via one or more input/output devices (now shown). Referring to FIG. 2A, the state of use sensor 202 can effectively indicate that one or more usable components 206A, 206B and 206C are active and/or being actively used. In addition, the state of use sensor 202 can effectively indicate the manner in which the active usable components (206A, 206B and 206C) are being used by the user 208. By way of example, the state of use sensor 202 can, for example, indicate the duration of activity for a particular application and/or the manner in which input/output has been provided by the user 208 in connection with the active application, and so on.

Those skilled in the art will readily appreciate that the state of use effectively sensed by the state of use sensor 202 can, for example, include one or more of the following: state of one or more applications, state of active use of one or more applications, state of active use including one or more variables associated with the manner in which the one or more applications have been used, state of one or more applications supported on the computing system, state of one or more active applications that are being effectively used on the computing system, and state of one or more active applications that are being effectively used by one or more persons who effectively interact with the one or more active applications via one or more input/output devices.

The other component of the pattern sensing system 102, namely, the contextual usage sensor 204, can effectively determine the context of use of the computing system 200. In general, the context of use determined by the contextual usage sensor 204 can include internal and external components, elements, variables and/or factors 208 and 210, as well the context of use of one or more usable components 206 themselves. As such, the contextual usage sensor 204 can, for example, determine the context of use based on one or more internal components of the computing system (e.g., timers, drivers, software modules) or internal factors and/or elements (e.g., CPU usage, memory available). The contextual usage sensor 204 can also determine the context of use based on a set of external components, variables, factors and/or elements 210 which can include an environment of use 212. Generally, the combination of contextual factors and the usable components 206 can be used to effectively represent a situation for the computing system. By way of example, the status (or status of use) of one or more usable components 206 and various internal and/or external variables can be considered by the context usage sensor 204 in determining the context that effectively represents a situation for the computing system 200.

It will be appreciated the environment of use 212 can, for example, represent the physical environment associated with one or more persons 208 who are interacting with the one or more active components 206A, 206B and 206C. The context of use can, for example, include one or more of the followings: an environmental factor and/or element, an environmental factor and/or element associated with one or more humans interacting with one or more active applications on said computing system, environmental context of use associated with an environment of one or more humans as they interact with one or more active applications on the computing system, a geographical and/or physical factor and/or element, time, date, location, mode, mode of operation, condition, event, speed and/or acceleration of movement, power and/or force, presence of one or more external components and/or devices, detection of more of more external devices in a determined proximity of said device, detection of one or more active components operating on one or more external devices in a determined proximity of the device, and one or more physiological and/or biological conditions associated with one or more persons interacting with the computing system.

As noted above, a situation can be determined also based one or more usable components (e.g., one or more applications) that are supported, operational, active and/or being actively used. As such, the context of use can, for example, be determined based on one or more of the following: one or more usable components of a computing system, one or more usable components of a computing system that are active and/or being used (e.g., one or more applications supported by said computing system, one or more applications of said computing system that are active and/or being used)

The state of use sensor 202 and contextual usage sensor 204 can effectively work together to provide integrated state and contextual usage data 214. Referring to FIG. 2, the integrated state and contextual usage data 214 can, for example, indicate that a number of usable components are active and additionally provide the state of use for each of the active applications (e.g., a state for each active application). It should also be noted that the state of use can include a set of factors associated with the manner of use of one or more of the active usable components (e.g., time active, input/output data provided in connection with the active components).

In addition to the state of use, the integrated state and contextual usage data 214 provides the context in which the usable components are used. Referring to FIG. 2A, the context includes internal variables (e.g., time, CPU usage) as well as external variables associated with the environment o fuse 212 (e.g., temperature, location, device that are in range).

It should be noted that the integrated state and contextual usage data 214 can be effectively provided as input to a transformer 216 which transforms the data into a form which is readily available for a pattern extractor 220 which is provided as a part of the pattern extractor/usage predictor 116. The pattern extractor 220 can effectively extract one or more usage patterns as pattern of use data 218 which can be stored in a database 223. A use predictor 221can effectively use the pattern of use data 218 in order to determine the likelihood of use of the computing system 200. It will be appreciated that the likelihood of use can be effectively provided to one or more internal or remote applications 222 in order to allow them to make certain predications about the use of the computing system 200.

FIG. 2B depicts a method 250 for determining a pattern of use of a computing system in accordance with one embodiment of the invention. The method 250 can, for example, be used by the computing system 200 shown in FIG. 2A. Initially, the state of use for one or more usable components of the computing system is obtained (252) as state of use information when the one or more usable components are being used. In addition, the context of use of the one or more usable components is obtained (254) as first contextual usage information when the one or more usable components are being used. It should be noted that the first contextual usage information effectively defines and/or indicates a first situation in which the one or more usable components have been used. Next, the first state of usage information and the first contextual usage information are combined (256) together to form integrated state and contextual usage data. It will be appreciated that the integrated state and contextual usage data effectively indicates that in the first situation, one or more usable components have been used in accordance with the first state of use. Thereafter, the integrated state and contextual usage data is transformed (258) to a pattern extraction ready form which allows extraction of one or more patterns of use based on one or more pattern extraction techniques. Accordingly, one or more patterns of use are extracted (260) from the pattern extraction ready form based on one or more pattern extraction techniques. Finally, the one or more extracted patterns of use are stored (262) as pattern of use data. It will be appreciated that the pattern of use data can be accessed by one or more applications in order to obtain the likelihood of use and/or make predictions regarding use of the computing system.

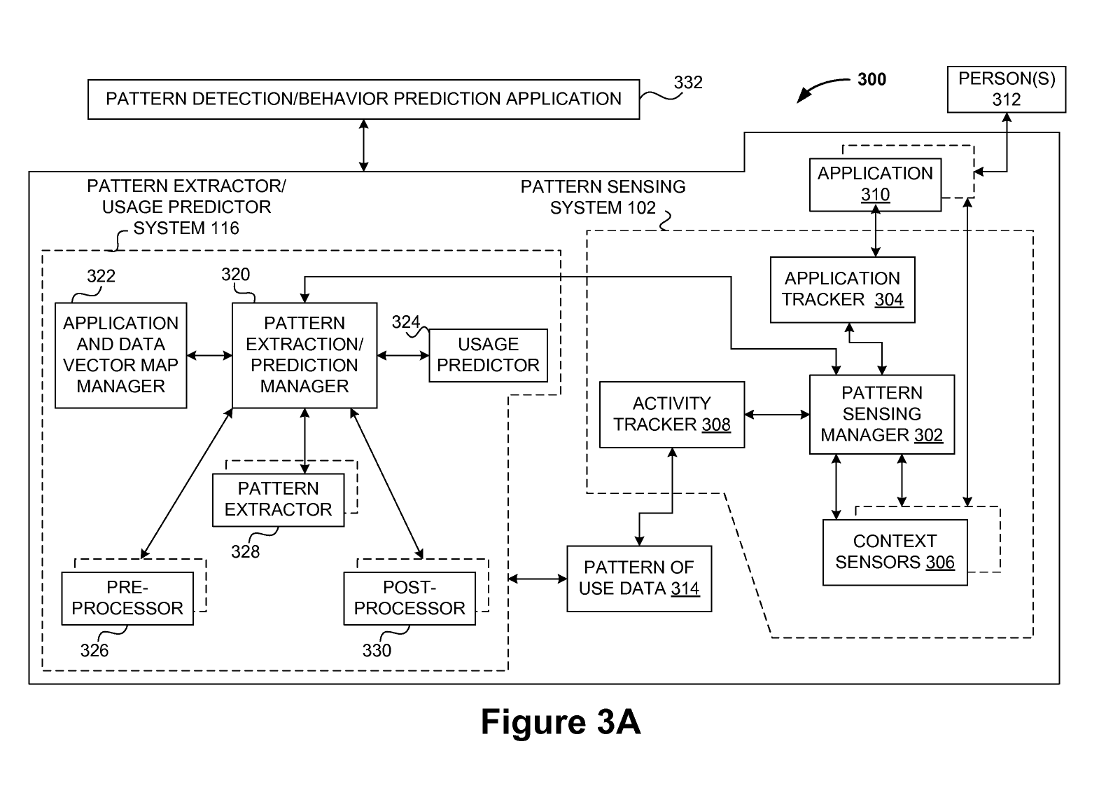

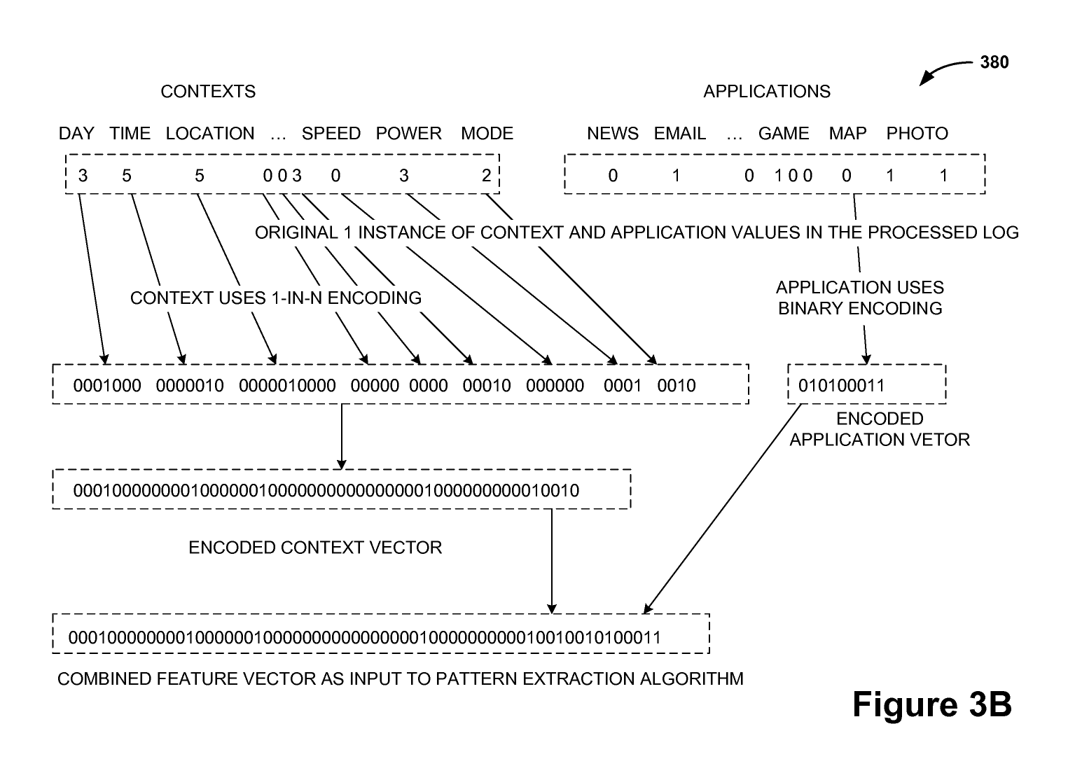

FIG. 3A depicts a computing system 300 in accordance with another embodiment of the invention. Referring to FIG. 3, a pattern sensing system 102 and a pattern extractor/usage predictor system 116 are effectively provided by the computing system 300. More particularly, a pattern sensing manager 302 effectively manages pattern sensing activities of an application tracker 304, one or more context sensors 306 and an activity tracker 308. The application tracker 304 tracks the activities of one or more application programs 310 which are operating on the computing system 300. The application tracker 304 can provide the state (or status) of use of the one or more application programs 310. The one or more context sensors 306 can effectively provide a context of use of the application programs 310. In other words, a context sensor 306 can sense a context in which one or more applications have been used as a situation. The context of use can, for example, be determined based on various internal and/or external components, factors, elements and/or variables including environmental factors associated with one or more persons 312 who are interacting with one or more applications 310, as well as the state of use of one or more applications 310.

Referring to FIG. 3A, the state of use and context of use of the one or more applications 310 can be provided as input to activity tracker 308 which in turn can transform the information into the pattern of use data 314. The pattern extraction/prediction manager 320 can effectively manage the activities of an application and data vector map manager 322 and a usage predictor 324. Those skilled in the art will appreciate that the application and data vector map manager 322 can effectively select one or more pre-processors 326 depending, for example, on the type of the variables and data used to generate pattern of use data 314, applications 310 and/or end-applications. In other words, the application and data vector map manager 322 can effectively select a pre-processing technique to pre-process the pattern of use data 314 for a particular application and/or in consideration of a particular data format and/or arrangement used to generate data or needed for further processing including pattern extraction. After the pre-processing, the pattern extraction/prediction manager can effectively use one or more appropriate pattern extraction techniques using one or more of the pattern extractors 328 in order to extract a pattern of use form the pattern of use data 314. Similarly, one or more post-processors 330 can effectively perform post-processing in order to, for example, present data in a form which may be suitable for one or more applications. In particular, the usage predictor 324 can effectively use the post-processed data in order to determine the likelihood of use and/or make predictions about the use of the one or more applications 310 in various situations effectively defined and/or identified by the contextual data. Furthermore, the usage predictor 324 can effectively provide information to a pattern detection/behavior prediction application which can use the information for various applications 332.

To further elaborate, FIG. 3B depicts a process 380 for generating pattern of use data in accordance with one embodiment of the invention. More particularly, FIG. 3B represents a very simple example where both the applications being used and the context of use (e.g., contextual factor, variables and/or elements) are fixed and known. Referring to FIG. 3B, the following context variables can be considered: location, co-locators, day of week, time of day, temperature, sound, speed, and the power of the device. Further, the following applications can be considered: news, email, music player, game, map, camera, note-taking, Web access, and communicator. User activity can be logged, for example, in a simple log when a user takes an action in connection with an application (e.g., when a user opens an application and starts to interact with the application, user activities in connection with the application can be logged). An entry in the log can, for example, have a timestamp followed by the values of the context variables measured for a particular application. The log can be processed to transform the timestamp into day of week, time of day, and so on. Numerous other transformations can be performed. For example, for enumeration-typed variables, integers can be used to represent the enumerations (e.g., 0 to 6 are used to represent the 7 days in a week). As another example, the range of the values of numerical variables can be divided into intervals and each interval can be represented by an integer, (e.g., sound level 0-20 dB can be represented by 0, 20-40 dB by 1, 40-60 dB by 2, and so on.

An encoded application vector (indicating the state of use of the applications) can be combined with an encoded context vector to provide a combined application and context vector which can be provided to one or more pattern extraction algorithms for pattern extraction, thereby allowing determining situational patterns of use for the applications based on various situations (i.e., contexts) that have been effectively observed and logged for the device.

Those skilled in the art will readily appreciate that various pattern extraction techniques can be used to determine a pattern of use for a computing system in accordance with various embodiments of the invention. By way of example, a co-clustering approach can be used for pattern extraction (e.g., Minimum-Sum Squared Residue Co-clustering (MSSRCC) technique can be used to capture coherent as well as homogeneous trends latent in a given data matrix.

In accordance with one embodiment of the invention, an innovative co-clustering algorithm can be applied to various applications including pervasive mobile computing. A traditional one-way k-means algorithm with Euclidean distance measure aims at discovering homogeneous patterns over all features, whereas an innovative co-clustering algorithm (e.g., a modified MSSRCC) can employ an alternating minimization scheme to optimize both row and column dimensions simultaneously in accordance with the invention. As such, the innovative co-clustering algorithm can generate co-clusters in a “checkerboard” structure from an input matrix, where a row vector can include both a context part and an application part. The centroids of these co-clusters can then be used for various applications including predicating the use of a mobile device given a particular situation.

In view of the foregoing, it will readily be appreciated that the invention has numerous advantages. For example, one or more of the embodiments of the invention can provide one or more of the following advantages: 1) there is no need for predefining situations to be considered in determining patters of use, 2) there is no need for user-defined profiles, 3) there is no need for supervised training, 4) the invention allows adaptation to changes in patterns of use (e.g., changes in behavior, or environment of use), and 5) virtually an unlimited number of components, factors, elements and/or variables can be considered to determine a situation (i.e., contextual use information associated with state of use information).

It will also be appreciated that the techniques of the invention are especially suitable for mobile systems (e.g., mobile devices). In particular, a “situation” can be effectively defined to be a set of relevant context values that are frequently associated with a pattern of use associated with one or more persons (or users) using a mobile device (i.e., a behavioral pattern of use). A usage history can effectively include user interactions with a mobile device along with the context in which the interactions have occurred. The usage history can be processed to extract patterns of use of the mobile device. Moreover, without requiring the user to provide input in order to effectively train the mobile device (i.e., supervised training), latent patterns of use (behavioral patterns) can be extracted from the usage history. A pattern of use can, for example, include latent situations and tasks frequently performed in the situations as they occur. As such, the pattern of use can provide valuable information including the likelihood of the use of a mobile device in a particular situation (e.g., for a given situation, the likelihood the application is going to be used and/or used in a particular manner can be determined). It will be appreciated that in order to protect user privacy, all that functions needed to extract a pattern of use can run on the mobile device itself.

The various aspects, features, embodiments or implementations of the invention described above can be used alone or in various combinations. The many features and advantages of the present invention are apparent from the written description and, thus, it is intended by the appended claims to cover all such features and advantages of the invention. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A computing system, comprising: one or more processors adapted for and/or capable of:
obtaining integrated state and contextual usage data for said computing system, wherein said integrated state and contextual usage data includes at least: (a) a first state of use of said computing system and (b) a first context for said computing system effectively represented as a first situation associated with said first state of use of said computing system, whereby effectively indicating that in said first situation said computing system has been used in accordance with said first state of use, and thereby allowing a pattern of use to be determined for said computing system at least based on the association of said first state of use with said first situation; and
determining, based on said integrated state and contextual usage data, a situational pattern of use for said computing system by detecting that in said first situation said computing system has been used in accordance with said first state of use.

2. The computing system of claim 1, wherein said first context includes one or more of the following:
state of use of one or more usable components of said computing system, thereby allowing said first situation to be determined based on said state of use of one or more usable components of said computing system;
one or more context variables associated with and/or determined by one or more internal and/or external components of said computing system;
one or more environmental variables associated with the physical and/or operational environment of said computing system;
one or more variables associated with one or more users of said computing system.

3. The computing system of claim 1,
wherein said one or more processors are further adapted for and/or capable of:
determining, based on a situational pattern of use, the likelihood of said computing system being used in accordance with said first state of use if said first situation occurs; and
wherein said determining of said situational pattern of use comprises: using one or more pattern extraction techniques to determine said situational pattern of use.

4. The computing system of claim 1, wherein said determining of said situational pattern of use further comprises: determining said situational pattern based on the frequency in which said first state of use occurs in said first situation.

5. The computing system of claim 1, wherein said determining of said situational pattern of use comprises: using one or more pattern extraction techniques to determine said situational pattern of use without receiving additional input.

6. The computing system of claim 1, wherein said determining of said situational pattern of use comprises: using one or more pattern extraction techniques to determine said situational pattern of use without requiring supervised learning.

7. The computing system of claim 1, wherein said determining of said situational pattern of use further comprises: determining said situational pattern of use based on the frequency in which first computing system has been used in accordance with said first state when said first situation occurs.

8. The computing system of claim 1,
wherein said obtaining of said obtaining integrated state and contextual usage data comprises one or more of the following:
defining, determining, receiving, selecting and/or identifying said integrated state and contextual usage data; and
wherein said first context includes the state of use of one or more usable components of said computing system, thereby allowing said situation to be determined based on said state of use of said one or more usable components of said computing system.

9. The computing system of claim 1, wherein said one or more processors adapted for and/or capable of:
obtaining said first state of use of said computing system based on the state of one or more components of said computing system;
obtaining said first context for said computing system; and
generating said integrated state and contextual usage data for said computing system.

10. The computing system of claim 9, wherein said first situation is not a predefined situation which has been defined prior to said obtaining of said first state of use, thereby allowing said pattern of use to be determined for said computing system without predefining a set of situations.

11. The computing system of claim 10, wherein said first state of use has not been defined prior to said obtaining of said first state of use, thereby allowing said pattern of use to be determined for said computing system without predefining a set of states of use.

12. The computing system of claim 1, wherein said first state of use of said computing system includes the state of one or more usable components of said computing system.

13. The computing system of claim 1, wherein said first state of use of said computing system includes the state of one or more usable components of said computing system which are active and being used by one or more persons who effectively interact with said one or more active applications via one or more input/output devices.

14. The computing system of claim 1, wherein said first state of use of said computing system includes one or more of the following:
state of one or more applications;
state of active use of one or more applications;
state of active use including one or more variables associated with the manner said one or more applications have been used;
state of one or more applications supported on said computing system;
state of one or more active applications that are being effectively used on said computing system; and
state of one or more active applications that are being effectively used by one or more persons who effectively interact with said one or more active applications via one or more input/output devices.

15. The computing system of claim 1, wherein said first context for said computing system is determined based on one or more of the following:
one or more internal components of said computing system,
one or more usable components of said computing system,
one or more internal factors and/or elements which are internal to said computing system, and
one or more external components, factors and/or elements that are external to said computing system.

16. The computing system of claim 1, wherein said first context for said computing system is determined based on one or more of the following:
an environmental factor and/or element,
an environmental factor and/or element associated with one or more humans interacting with one or more active applications on said computing system,
environmental context of use associated with an environment of one or more humans as they interact with one or more active applications on said computing system,
a geographical and/or physical factor and/or element;
time, date, location, mode, mode of operation, condition, event, speed and/or acceleration of movement, power and/or force,
presence of one or more external components and/or devices, detection of more of more external devices in a determined proximity of said device, detection of one or more active components operating on one or more external devices in a determined proximity of said device,
one or more physiological and/or biological conditions associated with one or more persons interacting with said computing system
one or more usable components of said computing system,
one or more usable components of said computing system that are active and/or being used
one or more applications supported by said computing system, and
one or more applications of said computing system that are active and/or being used.

17. The computing system of claim 1, wherein said first situation is not a predefined situation which has been defined prior to said obtaining of said integrated state and contextual data for said computing system, thereby allowing said pattern of use to be determined for said computing system without predefining a set of situations.

18. A computing system, comprising: one or more processors adapted for and/or capable of:
obtaining a first state of use of said computing system, wherein said first state of use is determined based on the state of one or more components of said computing system and said first state of use effectively indicates that said computing system is in a first state of use;
obtaining a first context for said computing system, wherein said first context effectively defines and/or indicates a first situation for said computing system; and
generating integrated state and contextual usage data for said computing system, wherein said integrated state and contextual usage data includes at least: (a) said first state of use of said computing system and (b) said first context for said computing system effectively represented as a situation associated with said first state of use of said computing system, whereby effectively indicating that in said first situation said computing system has been used in accordance with said first state of use, and thereby allowing a pattern of use to be determined for said computing system at least based on the association of said first state of use with said first situation.

19. A method for allowing a pattern of use to be determined for a computing system, said method comprising:
determining, based on the state of one or more components of the computing system, a first state of use of said computing system, wherein said first state of use effectively indicates that said computing system is in a first state of use;
determining a first context for said computing system, wherein said first context effectively defines and/or indicates a first situation for said computing system; and
generating integrated state and contextual usage data for said computing system, wherein said integrated state and contextual usage data includes at least: (a) said first state of use of said computing system and (b) said first context for said computing system effectively represented as a situation associated with said first state of use of said computing system, thereby allowing a pattern of use to be determined for said computing system at least based on the association of said first state of use with said first situation.

20. A method for determining a situational pattern of use for a computing system, said method comprising:
obtaining integrated state and contextual usage data for said computing system, wherein said integrated state and contextual usage data includes at least: (a) a first state of use of said computing system and (b) a first context for said computing system effectively represented as a situation associated with said first state of use of said computing system, and thereby allowing a pattern of use to be determined for said computing system at least based on the association of said first state of use with said first situation; and
determining, based on said integrated state and contextual usage data, a situational pattern of use for said computing system by detecting that in said first situation said computing system has been used in accordance with said first state of use.

21. A method for allowing a pattern of use to be determined for a computing system, said method comprising:
obtaining a state of use for one or more usable components of said computing system as state of use information when said one or more usable components are being used, wherein said state of use information effectively indicates a first state of use of said one or more usable components of said computing system;
obtaining a context of use of said one or more usable components of said computing system as first contextual usage information when said one or more usable components are being used, wherein said first contextual usage information effectively defines and/or indicates a first situation in which said one or more usable components have been used; and
combining said first state of use information and first contextual usage information together to form integrated state and contextual usage data that effectively indicates that in said first situation said one or more useable components have been used in accordance with said first state of use, thereby allowing a pattern of use of said computing system to be determined at least based on the knowledge of the use of said one or more usable components in accordance with said first state in said first situation.

22. The method of claim 21, wherein said method further comprises:
transforming said integrated state and contextual usage information to a pattern extraction ready form which allows extraction of one or more patterns of use based on one or more pattern extraction techniques.

23. The method of claim 22, wherein said method further comprises:
extracting one or more patterns of use from said pattern extraction ready form based on one or more pattern extraction techniques; and
storing said one or more patterns of use as pattern of use data which can be accessed by one or more applications in order to obtain a likelihood of use and/or make predictions regarding the use of said computing system.

24. The method of claim 23, wherein obtaining said likelihood of use includes one or more of the following:
determining the likelihood of one or more applications being used in a particular situation;
determining the likelihood that of one or more applications are being used in accordance with one or more states of use; and
determining the likelihood that of one or more applications are being used in accordance with one or more states of use in one or more specific situations.

25. The method of claim 21, wherein said pattern extraction technique uses a co-clustering approach.

26. The method of claim 25, wherein said co-clustering approach uses a Minimum-Sum Squared Residue Co-clustering (MSSRCC) approach.

27. The method of claim 25, wherein said co-clustering approach uses an alternating minimization scheme to optimize both row and column dimensions of a matrix, and wherein a row matrix includes both state of use and context of use data.

28. A computer readable medium including computer program code for allowing a pattern of use to be determined for a computing system, wherein said computer readable medium includes:
computer program code for obtaining a state of use for one or more usable components of a computing system as state of use information when said one or more usable components are being used, wherein said state of use information effectively indicates a first state of use of said one or more usable components of said computing system;
computer program code for obtaining a context of use of said one or more usable components of said computing system as first contextual usage information when said one or more usable components are being used, wherein said first contextual usage information effectively defines and/or indicates a first situation in which said one or more usable components have been used; and
computer program code for combining said first state of use information and first contextual usage information together to form integrated state and contextual usage data that effectively indicates that in said first situation said one or more useable components have been used in accordance with said first state of use, thereby allowing a pattern of use of said computing system to be determined at least based on the knowledge of the use of said one or more usable components in accordance with said first state in said first situation.

29. A computer readable medium including computer program code for determining a pattern of use for a computing system, wherein said computer readable medium includes:
computer program code for obtaining integrated state and contextual usage data for said computing system, wherein said integrated state and contextual usage data includes at least: (a) a first state of use of said computing system and (b) a first context for said computing system effectively represented as a situation associated with said first state of use of said computing system, thereby allowing a pattern of use to be determined for said computing system at least based on the association of said first state of use with said first situation; and
computer program code for determining, based on said integrated state and contextual usage data, a situational pattern of use for said computing system by detecting that in said first situation said computing system has been used in accordance with said first state of use.

30. The computing system of claim 1, wherein said computing system includes one or more of the following: a Smartphone, a wireless phone, a mobile phone, and a mobile device.
